(19) United States
(12) Patent Application Publication
(10) Pub. No.: US 2009/0221258 A1
(43) Pub. Date: Sep. 3, 2009

(54) Balanced Series Mixer for High-Frequency Signals

(75) Inventor: Dirk Steinbuch, Wimsheim (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/226,175

(22) PCT Filed: Mar. 23, 2007
(86) PCT No.: PCT/EP2007/052826

§ 371 Date: May 15, 2009

(30) Foreign Application Priority Data
Apr. 12, 2006 (DE) 10 2006 017 175.6

(51) Int. Cl. H04B 1/26

(52) U.S. Cl. 455/326

(57) ABSTRACT

A balanced series mixer including a balun transformer (10) having a HF-source port and an antenna port on one side and two diode ports on the other side, two diodes (20, 22), each of which is connected between one of the diode ports and a HF-ground (24, 26), and a useful-signal tap (48) for a mixed product generated by the diodes and made up of a HF-signal supplied via the antenna port and a portion of a HF-signal supplied via the HF-source port, characterized in that the diodes (20, 22) are in each instance biased via a bias feed line (50, 52) connected on the side of the HF-ground (24, 26), that the diodes are separated, in terms of direct current, from the useful-signal tap (48) and from the lines (34, 42) connected to the HF-source port and the antenna port, and that the two bias feed lines (50, 52) have low-pass filters (54) configured symmetrically relative to each other.

### FIELD OF THE INVENTION

The present invention relates to a balanced series mixer, having a balun transformer that has a HF-source port and an antenna port on one side and two diode ports on the other side, two diodes which in each case are connected between one of the. diode ports and a HF-ground, and a useful-signal tap for a mixed product that is generated by the diodes and is made up of a HF-signal supplied via the antenna port and a portion of a HF-signal supplied via the HF-source port.

### BACKGROUND INFORMATION

A series mixer is described in German Patent No. DE 196 10 850.

For example, such series mixers are used in radar sensors for proximity warning systems and control systems in motor vehicles. In the case of radar systems having a monostatic antenna design, one and the same antenna is used for transmitting the radar signal and for receiving the radar echo. The series mixer is then used to relay the signal, supplied via the HF-source port, to the antenna, and at the same time, to mix the signal received by the antenna with a portion of the signal supplied via the HF-source port. The mixed product is then an intermediate-frequency signal whose frequency indicates the difference in frequency between the transmitted and the received signal. This intermediate-frequency signal supplies information about the Doppler shift occurring in response to the reflection of the transmitted signal at the radar target, and thus about the relative velocity of the radar target and, provided the frequency of the transmitted signal is modulated in ramp-shaped fashion as in the case of a FMCW (frequency modulated continuous wave) radar, about the propagation time of the radar signal and therefore about the distance of the radar target, as well.

For this intended purpose, German Patent No. DE 102 35 338 describes a non-balanced mixer having only a single non-linear diode for mixing the high-frequency signals. In this mixer, a direct voltage (bias) is fed via the useful-signal tap in order to bias the diode, so that the working point of the diode can be optimized. This is advantageous if the high-frequency signals have a relatively low power which is not sufficient for a “self-bias” of the diode.

On the other hand, however, such a non-balanced mixer has the disadvantage that it also de-modulates the amplitude noise contained in the high-frequency signals, thereby impairing the quality of the useful signal. To nevertheless obtain a sufficiently low-noise useful signal, an extremely low-noise HF-source must therefore be used, e.g., a waveguide-based Gunn oscillator. However, such oscillators are relatively costly, and in addition, require complex balancing processes which further increase the production costs.

Instead of Gunn oscillators, it would therefore be advantageous from the standpoint of cost to use familiar MMIC (monolithic microwave integrated circuit) oscillators. However, they exhibit a higher amplitude noise.

### SUMMARY OF THE INVENTION

An object of the present invention is therefore to provide a balanced series mixer which, on the one hand, may be used in conjunction with HF-sources of low power, and on the other hand, permits an effective suppression of amplitude noise.

This objective is achieved by a balanced series mixer of the type indicated at the outset, in which the diodes are each biased via a bias feed line connected on the side of the HF-ground, the diodes are separated, in terms of direct current, from the useful-signal tap and from the lines connected to the HF-source port and the antenna port, and the two bias feed lines have low-pass filters configured symmetrically relative to each other.

The bias feed lines make it possible to bias the two diodes in such a way that, already in open-circuit operation, they are functioning close to their optimal working point. The optimal working point of the diodes is then reached by the relatively low power supplied from the HF-source. The low-pass filters prevent a short-circuit or an attenuation of the useful signal via the bias feed lines. Since the useful-signal tap as well as the HF-source and the antenna are decoupled from the diodes in terms of direct current, it is ensured that the bias direct current fed across one of the two diodes completely flows off again across the other diode, so that both diodes are traversed by an identical current. In conjunction with the symmetrical configuration of the low-pass filters in the two bias feed lines, it is thus ensured that the symmetry of the balanced mixer is not disturbed, and this is the decisive condition for effectively suppressing the amplitude noise.

For example, if the mixer of the present invention is used in a radar sensor, it is thus possible to employ an inexpensive but low-power MMIC oscillator as HF-source, and nevertheless to obtain a high-quality, in particular, low-noise useful signal.

In this application case, the antenna port is connected to the antenna of the radar sensor, thus clarifying the term “antenna port.” However, the field of application of the present invention is not intended to thereby be limited to the cases in which an antenna is actually connected to this port.

The decoupling of the useful-signal tap in terms of direct current is preferably realized via a series capacitor.

Preferably quarter-wavelength line couplers are used for the separation, in terms of direct current, of the mixer from the HF-lines connected to the HF-source port and the antenna port.

The symmetrically configured low-pass filters in the two bias feed lines are preferably R-C networks whose symmetrically set resistances then at the same time allow the setting of the bias.

The balun transformer (balanced to unbalanced transformer) is preferably implemented using stripline technology, and may be formed by a rat-race coupler or quadrature coupler. The diodes are preferably connected to the balun transformer via matching networks which allow an exact tuning or a controlled detuning of the diodes.

### BRIEF DESCRIPTION OF THE DRAWINGS

FIG. 1 shows a circuit diagram of the series mixer according to the present invention.

FIG. 2 shows an enlarged representation of a balun transformer in the series mixer according to FIG. 1.

### DETAILED DESCRIPTION

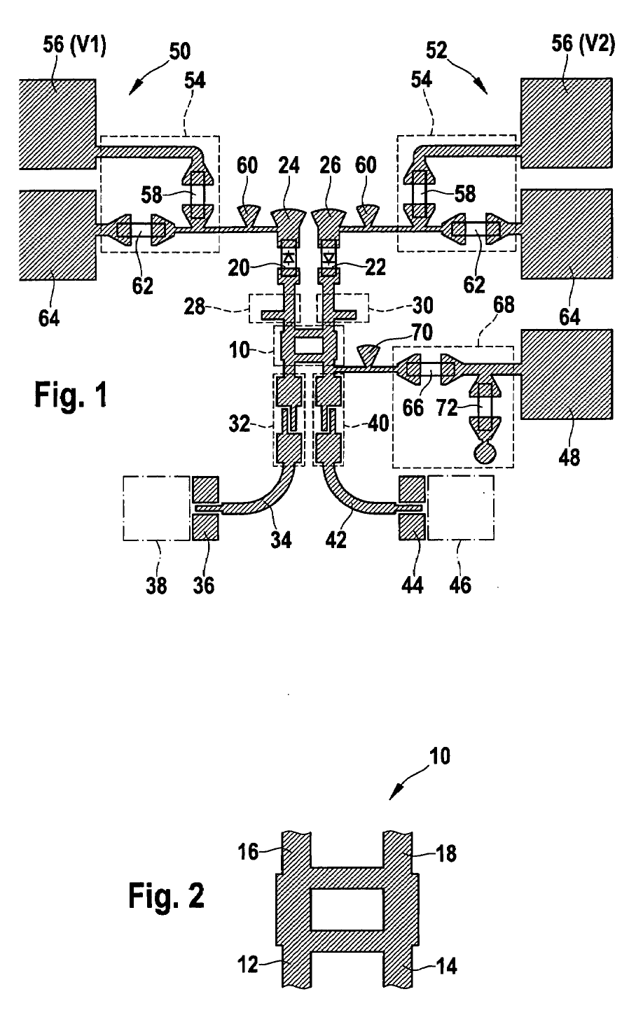

The balanced series mixer shown in FIG. 1 has a balun transformer 10 which, in the example shown, is formed by a quadrature coupler realized using stripline technology. This balun transformer 10, which is shown again enlarged in FIG. 2, has four ports interconnected in a rectangular configuration, namely, a HF-source port 12, an antenna port 14 and two diode ports 16, 18, of which one is situated opposite HF-source port 12, and the other is opposite antenna port 14.

The mixer shown in FIG. 1 also has two non-linear, identical diodes 20, 22 which are connected with opposite polarity between a respective HF-ground 24, 26 and one of diode ports 16, 18 of balun transformer 10. Matching networks 28, 30, respectively, are inserted between the diodes and the diode ports.

HF-source port 12 of balun transformer 10 is connected via a quarter-wavelength line coupler 32 to a line 34, that is connected via an input 36 to a HF-source, e.g., a MMIC oscillator 38.

Antenna port 14 of balun transformer 10 is connected via a further quarter-wavelength line coupler 40 to a line 42, that is connected via an input and output 44 to an antenna 46. MMIC oscillator 38 and antenna 46 are indicated here only by dot-dash lines, since they are not components of the mixer.

Balun transformer 10, taking the form of a quadrature coupler, has the characteristic that it is adapted to its HF-source port and antenna port 12, 14 when identical impedances are present at the two diode ports 16, 18. This adaptation may be achieved here with the aid of diodes 20, 22.

A HF-signal, generated by MMIC oscillator 38, is fed via line 34 to HF-source port 12, and is passed on via the two matching networks 28, 30 to diodes 20, 22. Depending on the tuning of diodes 20, 22, a greater or smaller portion of this signal is reflected and is fed via balun transformer 10 into line 42, and ultimately into antenna 46.

A HF-signal received by antenna 46 arrives via line 42 and balun transformer 10 at diodes 20, 22, and is mixed with the non-reflected portion of the HF-signal supplied via line 34 to form a useful signal which may be tapped at a useful-signal tap 48. The relation between the power converted by diodes, with respect to the power reflected and radiated via antenna 46 is set by controlled mismatch of diodes 20, 22.

To optimize the working point of diodes 20, 22, one bias feed line 50 and 52, respectively, is provided for each diode. Bias feed lines 50 and 52 are exactly symmetrical relative to each other and in each case include a low-pass filter 54.

In the case of bias feed line 50 for diode 20, a direct voltage V1 is applied to a bias terminal 56. This bias terminal is connected to HF-ground 24 via a resistor 58 of low-pass filter 54 and a filter 60 used as a high-frequency block. Low-pass filter 54 is formed by an R-C network that, in addition to resistor 58, has a capacitor 62 which is connected between the pole of resistor 58 connected to the high-frequency ground and a DC-ground 64.

Bias feed line 52 for diode 22 has the same construction, only a direct voltage V2 is applied to direct-voltage terminal 56. Preferably, it holds that V2=V1.

Useful-signal tap 48 is connected to antenna port 14 of balun transformer 10 via a series capacitor 66 of a further R-C network 68 and a filter 70 used as a high-frequency block, in order to tap the useful signal demodulated by diodes 20, 22.

With the aid of resistors 58, which have identical resistance values, diodes 20, 22 are biased in such a way that, in conjunction with the HF-power supplied by MMIC oscillator 38, they reach their optimal working point. At the same time, low-pass filters 54 prevent the useful signal, which is an intermediate-frequency signal, from leaking away via bias feed lines 50 and 52.

In addition to series capacitor 66, R-C network 68 also includes a resistor 72 connected to ground, and with its series capacitor 66, prevents the direct current, supplied by bias feed lines 50 and 52, from leaking away via useful-signal tap 48. In the same way, quarter-wavelength line couplers 32, 40 prevent the direct current from leaking away via lines 34 and 42. It is thus ensured that both diodes 20 and 22 are always traversed by the same current.

Filters 60 and 70 prevent the HF-signals from leaking away via bias feed lines 50 and 52 or useful-signal tap 48.

The symmetrical configuration of low-pass filters 54 ensures a perfect symmetry between diodes 20 and 22, so that the mixer operates as a balanced mixer and effectively suppresses an amplitude noise contained in the HF-signals, for instance.

Under suitable conditions, using the set-up described, it is possible to achieve a suppression of the amplitude noise by up to 50 dB. On the other hand, if resistor 58 and/or the capacitive coupling to DC-ground 64 is omitted in only one of the two low-pass filters 54, the suppression is only approximately 10 dB. In comparison, the sum of direct voltages V1 and V2 has only a slight influence on the suppression of the amplitude noise, so that it is also possible, for example, to set one of these two voltages to zero, and thus to dispense with a bipolar voltage supply.

By suitable bias of diodes 20 and 22, in general, it may be achieved that the suppression of the amplitude noise, as well as the AM/FM conversion are nearly constant in a relatively wide range of oscillator powers.

1-8. (canceled)

9. A balanced series mixer comprising:
a balun transformer having a HF-source port and an antenna port on one side and two diode ports on the other side;
two diodes, each of which is connected between one of the diode ports and a HF-ground; and
a useful-signal tap for a mixed product generated by the diodes and made up of a HF-signal supplied via the antenna port and a portion of a HF-signal supplied via the HF-source port,
wherein the two diodes are in each instance biased via a bias feed line connected on a side of the HF-ground,
wherein the diodes are separated, in terms of direct current, from the useful-signal tap and from lines connected to the HF-source port and the antenna port, and
wherein the two bias feed lines have low-pass filters configured symmetrically relative to each other.

10. The series mixer according to claim 9, wherein for a separation in terms of direct current, the HF-source port and the antenna port are connected via quarter-wavelength line couplers to the associated lines.

11. The series mixer according to claim 9, wherein the useful-signal tap is separated by a series capacitor from the diodes in terms of direct current.

12. The series mixer according to claim 11, wherein the useful-signal tap is connected to the antenna port of the balun transformer via the series capacitor.

13. The series mixer according to claim 9, wherein the low-pass filters are formed by R-C networks whose resistors have identical resistance values and determine a bias of the diodes.

14. The series mixer according to claim 9, wherein equal and opposite direct voltages are applied to the bias feed lines.

15. The series mixer according to claim 9, wherein the balun transformer is a quadrature coupler.

16. The series mixer according to claim 9, further comprising, in each case, a matching network situated between the diodes and the diode ports.
